(19) United States
(12) Patent Application Publication
(10) Pub. No.: US 2026/0236170 A1
(43) Pub. Date: Aug. 13, 2026

(54) CONTENTION AVOIDANCE DELAYS FOR ACCESSES TO SHARED MEMORY LOCATIONS

(71) Applicant: Arm Limited, Cambridge (GB)

(72) Inventors: Joshua RANDALL, Austin, TX (US); Alexander Donald Charles CHADWICK, Cambridge (GB); Eric Ola Harald LILJEDAHL, Stockholm (SE); Rajesh SHASHI KUMAR, Austin, TX (US)

(21) Appl. No.: 19/048,246

(22) Filed: Feb. 7, 2025

(51) Int. Cl. G06F 3/06

(52) U.S. Cl. CPC G06F 3/0611; G06F 3/0659; G06F 3/067

(57) ABSTRACT

Apparatuses, systems, chip-containing products, non-transitory computer-readable media and methods are disclosed. Load/store circuitry initiates a memory system transaction to access a shared memory location, wherein the shared memory location is accessible to multiple concurrent program threads. In response to an indication of concurrent access to the shared memory location by another program thread, the load/store circuitry causes a delay of reissuance of the memory system transaction by a delay period, wherein delay circuitry is configured to set the delay period in dependence on at least one factor determined at runtime.

### TECHNICAL FIELD

The present disclosure relates to data processing. In particular, the present disclosure relates to data processing involving multiple program threads executing concurrently.

### DESCRIPTION

A data processing apparatus may comprise multiple program threads executing concurrently, e.g. running on respective processor cores, where those multiple program threads may each then be able concurrently to access some shared data, e.g. held in a shared memory. When at least some of the multiple program threads are able to modify such shared data, there may be the need to manage accesses by respective program threads to a given shared memory location, to ensure correct synchronisation between the data processing performed by those program threads. In consequence, the access of a first program thread to the shared memory location can block a second program thread from accessing that shared memory location until the first program thread's access is complete.

### SUMMARY

In at least one example described herein there is an apparatus comprising: load/store circuitry configured to initiate a memory system transaction to access a shared memory location, wherein the shared memory location is accessible to multiple concurrent program threads, wherein the load/store circuitry is configured, in response to an indication of concurrent access to the shared memory location by another program thread, to cause a delay of reissuance of the memory system transaction by a delay period; and delay circuitry configured to set the delay period in dependence on at least one factor determined at runtime.

In at least one example described herein there is a system comprising: the apparatus described above, implemented in at least one packaged chip; at least one system component; and a board, wherein the at least one packaged chip and the at least one system component are assembled on the board.

In at least one example described herein there is a chip-containing product comprising the system described above, wherein the system is assembled on a further board with at least one other product component.

In at least one example described herein there is a non-transitory computer-readable medium storing computer-readable code for fabrication of an apparatus comprising: load/store circuitry configured to initiate a memory system transaction to access a shared memory location, wherein the shared memory location is accessible to multiple concurrent program threads, wherein the load/store circuitry is configured, in response to an indication of concurrent access to the shared memory location by another program thread, to cause a delay of reissuance of the memory system transaction by a delay period; and delay circuitry configured to set the delay period in dependence on at least one factor determined at runtime.

In at least one example described herein there is a method comprising: initiating a memory system transaction to access a shared memory location, wherein the shared memory location is accessible to multiple concurrent program threads; in response to an indication of concurrent access to the shared memory location by another program thread, delaying reissuance of the memory system transaction by a delay period; and setting the delay period in dependence on at least one factor determined at runtime.

### BRIEF DESCRIPTION OF THE DRAWINGS

The present invention will be described further, by way of example only, with reference to embodiments thereof as illustrated in the accompanying drawings, in which:

FIG. 1 schematically illustrates example instruction decoding circuitry, processing circuitry, and a shared memory;

FIG. 2 schematically illustrates an example apparatus having instruction decoding circuitry, processing circuitry, and access to a shared memory;

FIG. 3 schematically illustrates an example apparatus having an execution pipeline and access to a shared memory;

FIG. 4 schematically illustrates an example of a processing system comprising multiple processor cores which each access to a shared memory;

FIGS. 5A-5E illustrate examples of contention delay instructions;

FIGS. 6A and 6B schematically illustrate examples of load/store circuitry;

FIG. 7 illustrates a method for accessing a shared memory location; and

FIG. 8 illustrates a system and a chip-containing product.

### DESCRIPTION OF EXAMPLE EMBODIMENTS

Before discussing the embodiments with reference to the accompanying figures, the following description of embodiments is provided.

There exist concurrency mechanisms, such as spin locks, which may be invoked when a given program thread attempts to access a shared memory location but another program thread is still in the process of accessing that shared memory location. These mechanisms can often fail to scale though, as multiple threads attempt to access the shared memory location simultaneously. This deterioration in performance may for example be due to multiple reads/writes in the spin lock implementation that leads to unnecessary data movement. For example, when a processor core of the multiple processor cores running the multiple threads seeks to have a cache line corresponding to the shared memory location allocated into its local cache, only for that cache line to be requested by another processor core to be allocated into its own local cache. Hence memory system bandwidth is wasted on these repeated attempts for the data to be allocated into a different private cache, which can lead to the cache line ping-ponging between caches of multiple processor cores as the threads on those cores keep requesting the data and causing each other's cache entries for the cache line to be invalidated. In this context the inventors have realised that a delay left by load/store circuitry before reissuing a memory system transaction to access a shared memory location (when an indication of concurrent access to the shared memory location by another program thread is received) is a critical factor in improving overall system performance for the execution of the multiple program threads. Moreover they have realised that the dynamic nature of processing being carried out across such a system means that whilst a given delay period might be appropriate in some circumstances or for some configurations of the system, this same delay period may not be optimal under other circumstances or configurations. As such, the approach proposed by the present techniques is one in which this delay period is set dynamically (i.e. is not preconfigured for the apparatus), being determined at runtime. Accordingly, in some examples there is provided an apparatus comprising: load/store circuitry configured to initiate a memory system transaction to access a shared memory location, wherein the shared memory location is accessible to multiple concurrent program threads, wherein the load/store circuitry is configured, in response to an indication of concurrent access to the shared memory location by another program thread, to cause a delay of reissuance of the memory system transaction by a delay period; and delay circuitry configured to set the delay period in dependence on at least one factor determined at runtime. This ability of the apparatus to set the delay period in dependence on at least one factor determined at runtime provides a usefully adaptive approach, allowing the delay period to be modified appropriately for the context in which it occurs. In consequence, the performance of the apparatus and/or a system of which it forms part may be improved, by better selecting the moment in which to reissue a memory system transaction to access a shared memory location that was indicated to be the subject of concurrent access attempts by multiple threads. Memory system bandwidth may therefore also be better used, by reducing wasted repeated attempts for the data to be allocated into different private caches, and the cache line ping-ponging that can then ensue.

The delay to the reissuance of the memory system transaction may be implemented in a variety of ways, in particular the delay may be applied at a range of points in the apparatus in order to cause the required effect of the delay. Accordingly, the delay circuitry may be associated with a range of different components in the apparatus. In some examples, the delay circuitry is associated with the load/store circuitry and is configured to modify timing of an action of the load/store circuitry in order to implement the delay. In some examples, the apparatus further comprises an execution pipeline configured to execute a sequence of instructions defining a program thread and wherein the delay circuitry is associated with the execution pipeline, and the delay circuitry is responsive to a notification from the load/store circuitry of the indication of concurrent access to delay progress of at least one instruction through the execution pipeline in order to implement the delay. This delay of progress of at least one instruction through the execution pipeline may be implemented at any point in the execution pipeline. In some examples, the delay circuitry is configured to delay progress of the at least one instruction through the execution pipeline by delaying at least one of: fetching the at least one instruction; decoding the at least one instruction; dispatching the at least one instruction; renaming the at least one instruction; and/or issuing the at least one instruction.

The delay period may be set in dependence on only one factor, or several, that is or are determined at runtime. Moreover, the inventors have further realised that the programmer of the apparatus may be able to provide useful insight into how the delay should be set, for example in the knowledge of the program code context in which the memory system transaction is issued. In particular, the programmer's knowledge of the structure of the program code and of a critical section in the code of which a memory system transaction forms part, may allow the delay period before reissuing the memory system transaction to be varied such that likely unsuccessful reissuances are avoided. In order to support this programmer influence over the delay period, the inventors have proposed that a contention delay instruction is incorporated into the instruction set for the apparatus that allows that influence to be exerted. Accordingly, in some examples the apparatus further comprises instruction decoding circuitry configured to decode instructions of a program thread, wherein the delay circuitry is configured to set the delay period in further dependence on control signals generated by the instruction decoding circuitry in response to decoding a contention delay instruction. The contention delay instruction may exert control over the delay period in a variety of ways. For example, the instruction may reference a timing related register, such as a counter in the apparatus, with the delay value either being an absolute value or a relative value based on that counter value.

In another example, the instruction can specify a scaling factor to be applied to any other delay value (however derived). For instance, if the program has a critical section that averages four dependent memory accesses, the instruction could be used such that a scaling of the delay by a factor of 4 occurs, instead of some explicit timer value. Accordingly in some examples, the contention delay instruction comprises an indication of a scaling factor and the delay circuitry is responsive to the control signals generated by the instruction decoding circuitry to modify the delay period in dependence on the scaling factor.

Note that this scaling factor could be applied purely multiplicatively, but need not necessarily be used in that manner. For example, when multiple factors are combined, a range of products and/or sums of these can be implemented (e.g. factors, A, B and C could be combined as A*B*C or alternatively could be combined as A*B+C or any other combination). Multiple scaling factors may also be provided by multiple contention delay instructions added by the programmer. Accordingly in some examples, plural contention delay instructions each indicating respective scaling factors preceded the memory access instruction in the instructions of the program thread and the delay circuitry is configured to modify the delay period by a combination of the plural scaling factors of the plural contention delay instructions.

The present techniques further recognise that different system designs and system configurations will typically have different memory latencies. Moreover, the kind of shared memory location under consideration here may be used as a lock mechanism to protect one or more further memory locations involved in the critical section of program code, it is recognised that the critical section time could expand for a system design or configuration with longer memory latency than other systems. Accordingly, in some examples the at least one factor comprises a memory latency factor indicative of a relative latency of accessing the shared memory location. This relative latency may be determined in a variety of ways. For example, the typical latency of a shared memory location may be established at configuration/boot time and thereafter held as a reference value in the apparatus. Hence in some examples, the memory latency factor is a static value held as a boot-time set configuration value in the apparatus. Alternatively, the apparatus may be provided with the ability to determine or estimate the memory latency factor during the ongoing operation of the apparatus. Thus in some examples, the apparatus comprises memory latency determination circuitry configured to determine or estimate the memory latency factor during runtime. For example, if a system has a typical memory latency of 150 ns, the software could use a contention delay instruction that scales with this latency, and the resulting delay period may then for example be 100 ns. However, if the apparatus can detect dynamically the memory latencies it observes have doubled to 300 ns due to a loaded memory, it could double the back off time (delay period) for this instruction to be 200 ns, because the thread holding the lock is likely experiencing longer memory latency as well. For coarse-grained locks on some larger data structures, it might not be expected that the accesses to the protected data structure would be in a cache, so scaling the delay period with memory latency would be appropriate.

In a system with NUMA (non-uniform memory access) characteristics, the physical memory location of the shared memory location (e.g. holding a lock variable) may be taken into account. For instance, if the location is backed by physical memory on another chiplet, the critical section locations are also likely to be backed by memory on that NUMA node. For example, when the memory latency to access that NUMA node memory is around 500 ns, useful delay period may be 400 ns. Thus in some examples, the at least one factor comprises a physical memory location factor that is dependent on a proximity of the shared memory location to the load/store circuitry.

In some cases, the shared memory location may be within a cache in the system, such as a system level cache shared by a number of processing elements. Accordingly, the delay time may be set in dependence on at least one cache-related performance characteristic. In some examples, the apparatus is configured to share a system level cache and the at least one factor comprises at least one of: a system level cache latency; and/or a snoop hit latency. Such a delay setting could for example be triggered by a detection that a given critical section started by some PC typically hits in the system cache or could be based on a hint provided by the programmer, where the present techniques propose a dedicated hint for this purpose. In the latter case therefore, the delay circuitry may be responsive to control signals generated by the instruction decoding circuitry in response to decoding a shared cache hint instruction to set the delay period in dependence on at least one of: the system level cache latency; and/or the snoop hit latency. Further hardware may be provided for the purpose of monitoring relevant system level cache activity and accordingly in some examples, there is system level cache hit monitoring circuitry, and the delay circuitry is responsive to a system level cache hit indication from the system level cache hit monitoring circuitry to set the delay period in dependence on at least one of: the system level cache latency; and/or the snoop hit latency.

The indication of concurrent access to the shared memory location may itself take a variety of forms and may comprise additional information related to the concurrent access. In some examples the indication of concurrent access to the shared memory location further comprises a contention level indication, and the delay circuitry is configured to use the contention level indication as the at least one factor when setting the delay period.

Such a contention level indication may take a variety forms and convey various information. In some examples, the contention level indication is provided by a remote node via which access to the shared memory location is made. For example in a coherent memory system a fully coherent home node (HN-F) may provide this information. In some examples, the contention level indication is indicative of an activity level of the remote node. In some examples, the contention level indication is indicative of a number of requests at the remote node that were hazarded on the shared memory location. This may be with respect to a previous access to the shared memory location. In some examples, the contention level indication is indicative of a recent number of accesses via the remote node to the shared memory location. Such examples of historical activity may give a useful indication of how likely contention is to occur in the near future and at what level.

Although the delay period may be variably set, in some cases it may be desirable for there to be a maximum back-off time (i.e. a maximum delay period) for which reissuances of the memory system transaction will occur. This thus limits the duration for which execution can be blocked, before the software can do something else or, for example, can yield to the operating system scheduler. This may be of particular benefit for very long and/or very contended critical sections. For example, if some software is written which should not “spin” (i.e. wait for the hardware delay mechanism to resolve) for more than 1 ms, and contention delay instruction is used which will allow a maximum timeout of 10 μs, this would allow it to spin 100 times. The maximum back-off time could be architected in the instruction or in a system register defined by the implementation. Alternatively, software could provide an argument to the instruction to set a maximum back-off time to set its expected QOS. Accordingly in some examples the contention delay instruction further comprises a maximum back-off control value and the delay circuitry is configured to limit in dependence on the maximum back-off control value a period for which reissuances of the memory system transaction will occur.

In some examples there is provided a system comprising: the apparatus of any of the examples given above, implemented in at least one packaged chip; at least one system component; and a board, wherein the at least one packaged chip and the at least one system component are assembled on the board.

In some examples there is provided a chip-containing product comprising the above system, wherein the system is assembled on a further board with at least one other product component.

In some examples, there is provided a non-transitory computer-readable medium storing computer-readable code for fabrication of an apparatus comprising: load/store circuitry configured to initiate a memory system transaction to access a shared memory location, wherein the shared memory location is accessible to multiple concurrent program threads, wherein the load/store circuitry is configured, in response to an indication of concurrent access to the shared memory location by another program thread, to cause a delay of reissuance of the memory system transaction by a delay period; and delay circuitry configured to set the delay period in dependence on at least one factor determined at runtime.

In some examples there is provided a method comprising: initiating a memory system transaction to access a shared memory location, wherein the shared memory location is accessible to multiple concurrent program threads; in response to an indication of concurrent access to the shared memory location by another program thread, delaying reissuance of the memory system transaction by a delay period; and setting the delay period in dependence on at least one factor determined at runtime.

Particular embodiments will now be described with reference to the figures.

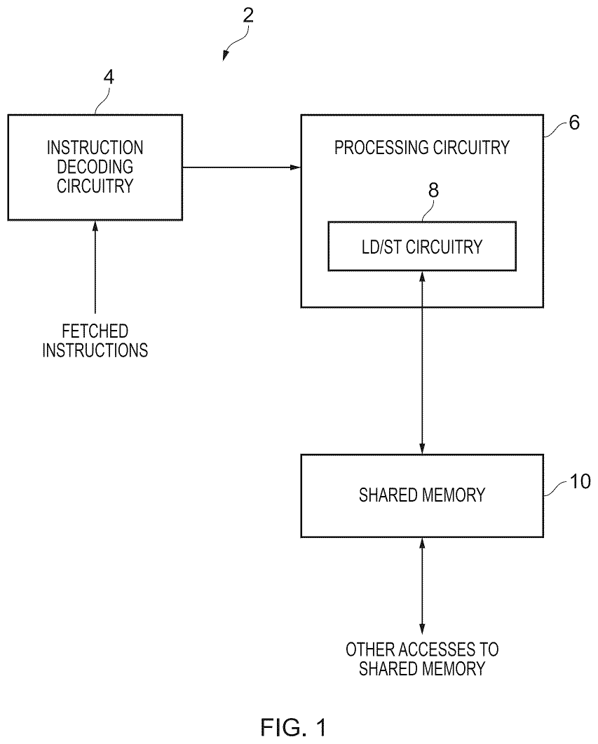

FIG. 1 shows an example of an apparatus 2, which may for example be a processor core, such as a central processing unit (CPU). The apparatus 2 includes instruction decoding circuitry 4 for decoding instructions fetched from a cache or memory storage unit of a memory system. The instructions are encoded according to a particular instruction set defined by an instruction set architecture (ISA) supported by the apparatus 2. The ISA defines, for each instruction encoding, which operation is represented by the instruction, including the operands of the instruction and a destination for the results that are to be generated in response to the instruction. Based on decoding the instruction, the instruction decoding circuitry 4 generates control signals for controlling processing circuitry 6 to perform the operation represented by the instruction. The processing circuitry 6 includes one or more execution units for executing different classes of instructions. One particular execution unit may be a load/store unit 8, which executes load/store operations in response to load/store instructions decoded by the instruction decoding circuitry 4. It will be appreciated that the processing circuitry 6 may also include other types of execution unit, such as one or more arithmetic/logical units (ALUs) for performing integer or floating-point arithmetic/logical operations, a branch unit for processing branch instructions, and/or a vector processing unit for performing vector processing operations on vector operands providing multiple distinct data elements in one register. The load/store circuitry 8 is provided to enable the processing circuitry 6 to access data values in memory that are the subject of its data processing operations. For example, a data value at a memory location specified in a load instruction is caused to be retrieved from that memory location and brought into the processing circuitry (held in a register) to be used in a data processing operation. Modified data values can be stored back to their respective memory locations. It will be understood that various cache levels may be interposed between the processing circuitry and the actual memory location of the data value, in order to improve access latencies. FIG. 1 shows a shared memory to which the processing circuitry 6 has access and to which other processing elements in the wider system to which the processing circuitry 6 belongs have access as well. This sharing of memory enables the data processing operations of the multiple processing elements in the system to be cooperative, such that data processing tasks can be parallelised to a certain extent by distributing the required processing across those multiple processing elements, for example by the use of multi-threaded software. Nevertheless, whilst some of the data processing to be carried out can be fully parallelised, some parts of the processing must be carried out in a more coordinated manner, for example where more than one processing element has access to certain shared data, and steps must be taken to ensure that the respective data processing performed by the multiple processing elements do not conflict with one another. Concurrency mechanisms such as spin locks may be implemented, such that only one executing thread can lock a given data structure in memory, and other executing threads will spin whilst waiting for that lock to be released. Such concurrency mechanisms can be used to ensure that critical sections of program code (i.e. portions of code that must be able to have exclusive access to a given data structure) are correctly performed. For the arrangement shown in FIG. 1, it is can therefore be envisaged that the processing circuitry 6 (via its load/store unit 8) might access a shared memory location in the shared memory 10 and set a lock value there, which then prevents other processing elements that have access to the shared memory location from accessing any data structures protected by that lock value. Equally, when another processing element has set the lock value, an attempt by the processing circuitry 6 to modify that lock value and thereby gain access to the data structures protected by that lock value would fail. The multi-threaded software underlying this behaviour may have some spin-wait or back-off functionality, such that after a delay period the processing circuitry 6 will again seek to take control of the lock/protected data structure. The software can further comprise a control path that monitors the execution delay caused by such back-offs and intervenes after a given time delay or number of back offs to yield execution to the operating system scheduler. The present techniques recognise that critical sections have varying lengths and characteristics, so the ideal back-off time can vary depending on the software context, the current memory access latencies, dynamic contention levels, and so on. Accordingly, the load/store circuitry 8 is responsive to the indication of concurrent access to cause a delay period to be set (where that delay period must elapse before reissuing of the memory access) in dependence on at least one factor determined at runtime. The range of factors are discussed in more detail in the following.

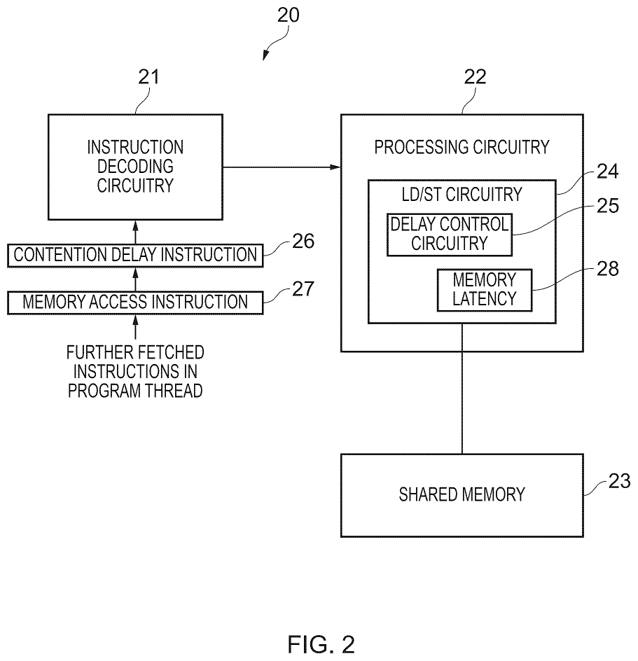

FIG. 2 schematically illustrates an example apparatus 20 having instruction decoding circuitry 21, processing circuitry 22, and access to a shared memory 23. The processing circuitry 22 comprises a load/store unit 24. These components operate as described with reference to the example described in FIG. 1. The load/store unit 24 comprises delay control circuitry 25, which is configured to determine a delay period for which the load/store unit 24 will wait before reissuing a memory system transaction to a shared memory location, when an indication of concurrent access to that shared memory location has been received in response to an earlier issued memory transaction. The delay period is dynamically determined at runtime. One mechanism that can exert control over the determination of the delay period is illustrated in the example of FIG. 2 by the contention delay instruction 26 shown being received by the instruction decoding circuitry. Decoding and execution of this contention delay instruction 26 configures the delay control circuitry 25, in particular regard to its determination of the delay period. The contention delay instruction 26 is shown to be followed in the example of FIG. 2 by a memory access instruction 27. This allows the programmer to use the contention delay instruction 26 to preconfigure the delay control circuitry 25 before the execution of the memory access instruction 27, such that in the event that a first attempt to perform the memory access specified by the memory access instruction 27 is unsuccessful, the delay control circuitry 25 then applies a delay period as configured by the contention delay instruction 26. The contention delay instruction 26 may take various forms, passing various values or parameters to the delay control circuitry 25, depending on the form of the modification of the delay period that is required. Separately it is to be noted that, other than its influence over the configuration of the delay control circuitry 25, the contention delay instruction 26 passes through the execution pipeline of the processing circuitry as a NOP (no-operation), meaning that the introduction of this instruction to an existing instruction set will preserve backwards compatibility for older hardware that does not have delay control circuitry responsive to such an instruction.

One example of the use of the contention delay instruction 26 is for the instruction to choose or influence the delay period through an operand in the instruction. For example, this operand could identify a register that specifies the delay period based on an architectural counter (such as CNTVCT (i.e. typically CNTVCT_EL0) in the Arm architecture). The time value could be specified as an absolute value or a relative value. Another example of the use of the contention delay instruction 26 is for the instruction to specify a scaling factor. For instance, if the programmer recognises that there is a critical section of program code that averages 4 dependent memory accesses, they can use this type of contention delay instruction to provide an argument that scales the delay by 4 instead of some explicit timer value. This scaling factor may be applied to any other delay period used (howsoever determined) according to any of the other examples disclosed herein. In a further variant, multiple instances of the contention delay instruction might be used in succession in order to apply a scaling factor, e.g. executing two contention delay instructions one after the other in order to double whatever the delay factor would have been following the use of just one contention delay instruction. It is to be noted that when multiple scaling factors are applied, they need not be combined purely multiplicatively. For example, when multiple factors are combined, a range of products and/or sums of these can be implemented (e.g. factors, A, B and C could be combined as A*B*C or alternatively could be combined as A*B+C or any other combination).

A further aspect of the load/store unit 24 is its ability to factor memory latency into its determination of the delay period. In one example, the memory latency unit 28 is configured to hold a value representative of the memory (access) latency of the shared memory 23, where this latency is determined at configuration/boot time. For example, the typical memory latency to the shared memory could be 150 ns and software could then use a contention delay instruction that to determine the delay period based on this latency. In this example a suitable delay period could then be, say, 100ns. In another example, the memory latency unit 28 is configured to dynamically detect memory latencies on the basis of the memory accesses handled by the load/store unit 24. In the same example system, the memory latency unit 28 might for example detect that typical memory access latencies to the shared memory have doubled to 300 ns (due to additional loading of the memory from other system requests). In this case, the delay control unit 25 can then double the delay period (in this case to 200 ns), because the thread holding the lock is likely experiencing longer memory latency as well and therefore the critical section of code will take commensurately longer to complete. It is noted that scaling the delay period with memory latency will be of particular applicability for instances of coarse-grained locks on some larger data structures (for which it might not be expected that the accesses to the protected data structure would be cached—and hence quicker to access than this memory latency). Note further that in a system with NUMA (non-uniform memory access) characteristics, the physical memory location of the shared memory location (e.g. holding a lock variable) may be similarly taken into account. For instance, if the lock location is backed by physical memory on another chiplet, the critical section locations are also likely to be backed by memory on that NUMA node. The memory latency to access that NUMA node memory may by 500 ns, so a suitable back-off time (delay period) may be 400 ns. The memory latency unit 28 can be configured to store a range of memory latencies together with associated memory location indications, such that the delay control unit 25 can select an appropriate memory latency value depending on the particular shared memory under consideration.

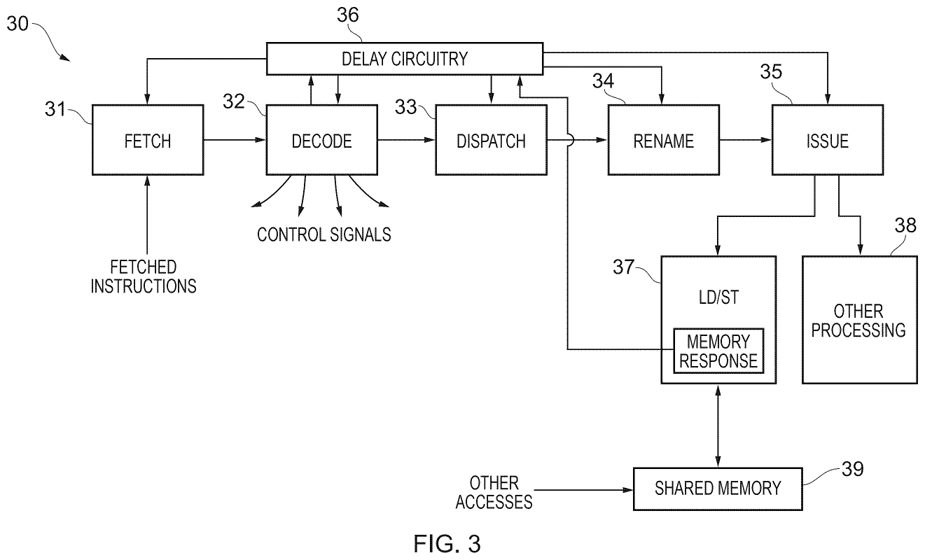

FIG. 3 schematically illustrates an example of an apparatus 30 that is shown to have an execution pipeline. The execution pipeline is schematically illustrated by the stages: fetch 31, decode 32, dispatch 33, rename 34, and issue 35. The issue stage feeds the execution units, of which only two are shown in this simplified illustration, namely the load/store unit 37 and “other processing” 38. In a manner with which one of ordinary skill in the art is familiar, instructions caused to be fetched by the fetch stage 31 are received by that stage and passed to the decode stage 32 for decoding. The decode stage 32 generates control signals in dependence on each instruction decoded and these control signals can steer the operations of all of the other components of the apparatus to cause the apparatus to perform the data processing defined by the instructions. Delay circuitry 36 is associated with the pipeline and also receives control signals from the decode stage 32. The delay circuitry 36 is arranged to receive an indication from the load/store unit 37 when a memory response 44 indicates concurrent access to the shared memory location by another program thread. In the same manner as the delay control circuitry described elsewhere herein, the delay circuitry 36 determines a delay period for which another attempt to access the shared memory location should “back-off” before being reissued. This delay period is determined dynamically at runtime as described elsewhere herein, for example on the basis of a measured memory latency. The delay period can also be modified by some examples of the above-mentioned contention delay instruction, whereby decoding of such an instruction by the decode stage 32 is signalled to the delay circuitry 36, which in turn can delay progress instructions through the execution pipeline by pausing the operation of any of the stages of the pipeline. For example, the delay may be applied at the issue stage, preventing any further instructions from being issued until the delay period elapses. In another example, decoding of the contention delay instruction could cause the delay to be applied in the decode stage itself, pausing further decoding following the indication of concurrent access to the shared memory location until the delay period elapses. Any of the pipelines stages can be similarly paused in this manner.

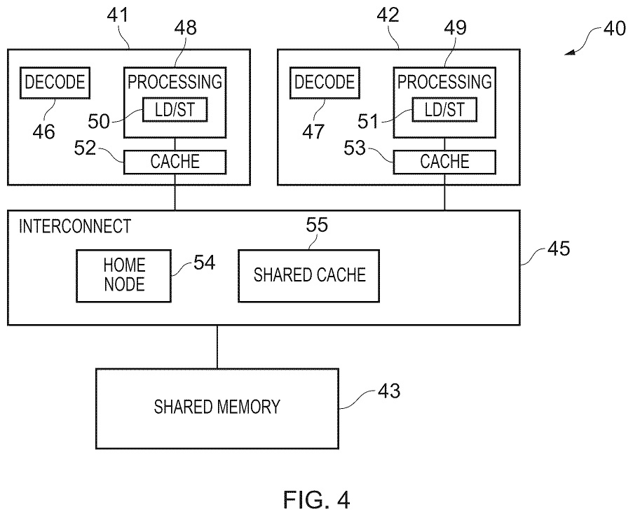

FIG. 4 schematically illustrates an example of a processing system 40 comprising multiple processor cores 41, 42 which each access to a shared memory 43. Access to the shared memory 43 is mediated by the interconnect 45 to which each of the processor cores 41, 42 is connected. The example only shows two processor cores connected in this manner (for clarity of illustration), but the present disclosure is not limited to this number in any way. Each processor core comprises instruction decoding circuitry 46, 47, processing circuitry 48, 49 (themselves each comprising a load/store unit 50, 51. These components operate as described with reference to the examples described in any of FIGS. 1-3. Each processor core further comprises a local cache 52, 53. The interconnect 45 comprises a home node 54 and a shared system cache 55. For example, the home node 54 may be a fully coherent home node (HN-F) as part of a coherent interconnect structure. In an example system such as that shown in FIG. 4, the contended variable of the shared memory location may be held in the system cache 55. Accordingly, in this situation the delay period may be scaled based on the system cache latency or a snoop hit latency. Applying this cache-based latency scaling to the delay factor could be initiated by detection that a relevant memory access typically hits in the system cache. Alternatively, the present techniques further disclose a shared cache hint instruction by means of which the programmer can provide a hint that a subsequent memory access (i.e. one known to be accessing a likely contended shared memory location) is likely to be present in the system cache, and in response to which the delay period can be appropriately set, based on cache latency timing characteristics. For example if snoops typically take 50 ns to retrieve from another core's cache, the delay period could be set to, say 40 ns.

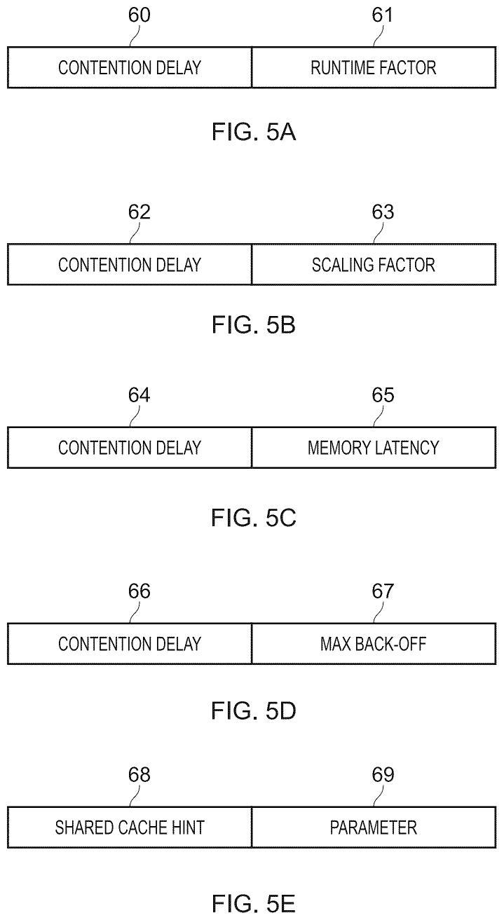

FIGS. 5A-5E illustrate examples of contention delay instructions. FIG. 5A illustrates a generic example of a contention delay instruction, wherein an opcode portion 60 of the instruction indicates to the decoding circuitry that this is a (certain type of) contention delay instruction, whilst another portion 61 of the instruction indicates to the decoding circuitry a given runtime factor on the basis of which load/store circuitry is to determine a delay period to be applied before reissuance of a memory system transaction targeting a shared memory location, when an indication of concurrent access to that shared memory location by another program thread has been received. FIG. 5B shows a scaling factor example, whereby the instruction comprises an opcode portion 62 and a scaling factor 63. FIG. 5C shows a memory latency example, whereby the instruction comprises an opcode portion 64 and an indication 65 of a memory latency that should form the basis of the delay period determination. FIG. 5D shows a maximum back-off example, whereby the instruction comprises an opcode portion 66 and an indication 67 of a maximum back-off, i.e. a maximum period for which the load/store circuitry should allow the software to spin for, before execution is unblocked. FIG. 5E shows an example of a shared cache hint instruction which may be used by the programmer to suggest to the load/store unit the a calculated delay period should be based on a typical cache latency (rather than a typical memory latency, say), because the programmer expects the contended variable to held in the cache. This instruction comprises an opcode portion 68 and a parameter 69, which may be used to convey further control information to the load/store unit.

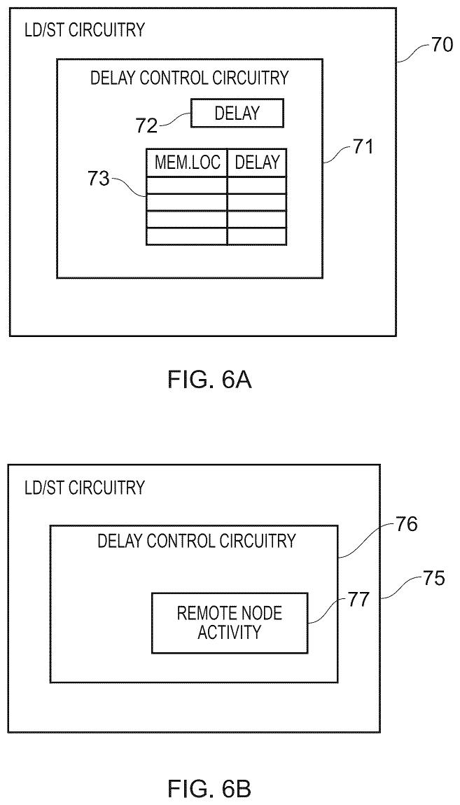

FIGS. 6A and 6B schematically illustrate examples of load/store circuitry. In the example of FIG. 6A, the load/store circuitry 70 comprises delay control circuitry 71, which itself comprises a delay value storage 72, to which the delay control circuitry has access when determining the delay period. This may for example hold a delay period determined during system configuration/boot-up and which can then be referred to during the ongoing operation of the system. The delay control circuitry 71 also comprises a delay value table 73 in which delay periods (or memory latencies on which delay periods are based) can be stored in association with indications of different memory locations. These periods or latencies may also be determined during system configuration/boot-up and can then be referred to during the ongoing operation of the system. In the example of FIG. 6B, the load/store circuitry 75 comprises delay control circuitry 76, which itself comprises a remote node activity unit 77. The remote node activity unit is configured to track activity of at least one remote node (via which the load/store circuitry 75 accesses at least one shared memory location). This activity level may then serve as an quantification of the likelihood of contention occurring and may be characterised in various ways. For example: a remote node may provide an indication of a general level of activity (or “busyness); a remote node may provide an indication of a number of requests at the remote node that were hazarded on the shared memory location for a previous access to that shared memory location; or a remote node may provide an indication of a recent number of accesses via the remote node to the shared memory location. The delay control circuitry 76 can factor any or all of these indications into its determination of the delay period.

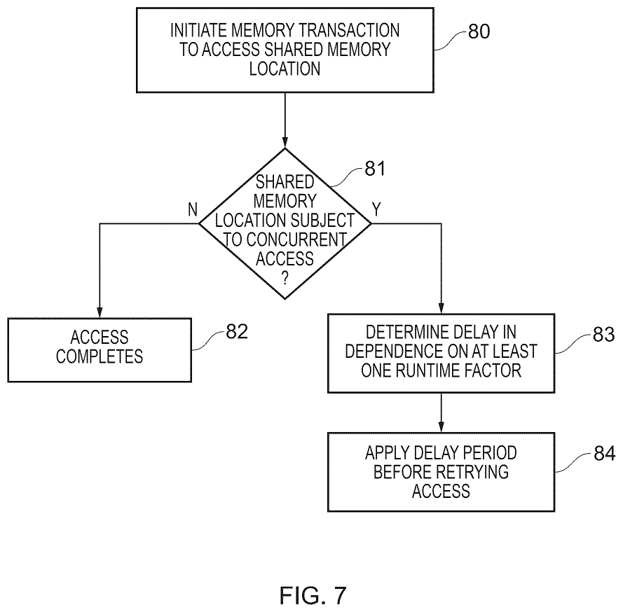

FIG. 7 illustrates a method for accessing a shared memory location. At step 80 a memory transaction to access a shared memory location is initiated. At step 81, it is determined whether an indication has been received that the shared memory location is currently subject to concurrent access. When this is not the case, the flow concludes at step 82 and the access completes. When this is the case, the flow proceeds to step 83 at which load/store circuitry determines a delay period in dependence on at least one runtime factor. The delay period is then applied before the access is retried at step 84.

As mentioned above, the load/store circuitry may determine an appropriate delay period (back-off time) in dependence on several factors that combine. Take for example a program that has a critical section that typically updates 4 locations in a data structure, where there is an address dependency between them (pointer-linked) so in the case of an out-of-order processor, the accesses will not be parallelized. The software could specify a back-off scaling factor of 4 to the instruction (by placing this value in a suitable register) to indicate that the hardware should consider four times the normal expected critical section time. When the contention delay (back-off) instruction is encountered, the hardware could notice that the preceding data access (that was to the lock variable) was to a local memory that typically takes 150 ns (where this latency has been exposed by the hardware/boot configuration storing the expected latency as 150 ns in a system register). In this case, the hardware could expect the current critical section to take 4 successive memory latencies of 150 ns, so 600 ns total. So given this information, the implementation might determine a 500 ns back-off time for this instruction, so that software would re-attempt taking the lock when it is likely free again.

Further, consider the situation in which the memory system returned an indication that there were 10 address-hazarded requests at the HNF when this processing element's request arrived. If this information is returned in the interconnect response, this indicates a very high number of contending threads, and each of these threads is attempting a critical section expected to be 600 ns. The determination could be made to expand the back-off time by 10, or alternatively by a lower factor such as 5 (half the contending threads) in order to not back off too far. In this case one option would be to back off by 5 iterations of 500 ns, or 2500 ns. Due to the high level of observed contention and the long expected critical section, such a long back-off could help overall throughput of the lock. As mentioned above, the scaling of these delays doesn't necessarily need to be linear. This could be a sub-linear function such that these factors don't cause too long a delay. A simple example would be to divide any delay in excess of 500 ns by four. In the above case, where the observation of 10 threads contending for a critical section of 500 ns has been made, instead of multiplying the delay by 11, it could be increased by a quarter of that [500+(500*11/4)], yielding a delay of 1875 ns.

Yet further, it might be the case that the software wants to check 100 times before yielding to the scheduler and it doesn't want to wait more than 1 ms before yielding, because there may be other work to perform on different threads. It could specify in a register that the maximum back-off is 1 μs by giving a value based on some timer frequency, such as one indicated in a counter timer frequency register (i.e. cntfrq_el0 in the Arm architecture). If that frequency is 1 GHz, the maximum timeout register that software provides could use the value 1,000 to get a maximum timeout of 1 us. In this way, the software could provide all the necessary information for the hardware to delay for an optimized amount of time, taking into account the expected critical section length, active contention, and desired level of software control to optimize the lock back-off.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

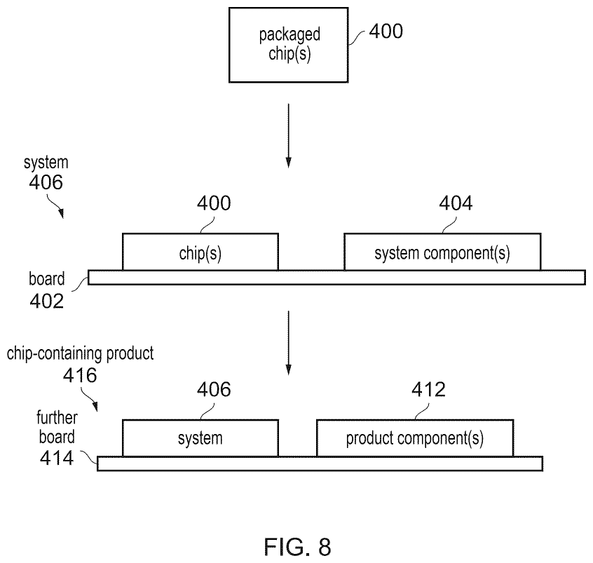

As shown in FIG. 8, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Various disclosed configurations are set out in the following numbered clauses:

Clause 1. Apparatus comprising:
load/store circuitry configured to initiate a memory system transaction to access a shared memory location, wherein the shared memory location is accessible to multiple concurrent program threads,
wherein the load/store circuitry is configured, in response to an indication of concurrent access to the shared memory location by another program thread, to cause a delay of reissuance of the memory system transaction by a delay period; and
delay circuitry configured to set the delay period in dependence on at least one factor determined at runtime.

Clause 2. The apparatus of Clause 1, wherein the delay circuitry is associated with the load/store circuitry and is configured to modify timing of an action of the load/store circuitry in order to implement the delay.

Clause 3. The apparatus of Clause 1, further comprising an execution pipeline configured to execute a sequence of instructions defining a program thread and wherein the delay circuitry is associated with the execution pipeline, and
wherein the delay circuitry is responsive to a notification from the load/store circuitry of the indication of concurrent access to delay progress of at least one instruction through the execution pipeline in order to implement the delay.

Clause 4. The apparatus of Clause 3, wherein the delay circuitry is configured to delay progress of the at least one instruction through the execution pipeline by delaying at least one of:
fetching the at least one instruction;
decoding the at least one instruction;
dispatching the at least one instruction;
renaming the at least one instruction; and/or
issuing the at least one instruction.

Clause 5. The apparatus of any of Clauses 1-4, further comprising:
instruction decoding circuitry configured to decode instructions of a program thread, wherein the delay circuitry is configured to set the delay period in further dependence on control signals generated by the instruction decoding circuitry in response to decoding a contention delay instruction.

Clause 6. The apparatus of Clause 5, wherein the contention delay instruction comprises an indication of a scaling factor and the delay circuitry is responsive to the control signals generated by the instruction decoding circuitry to modify the delay period in dependence on the scaling factor.

Clause 7. The apparatus of Clause 6, wherein plural contention delay instructions each indicating respective scaling factors preceded the memory access instruction in the instructions of the program thread and the delay circuitry is configured to modify the delay period by a combination of the plural scaling factors of the plural contention delay instructions.

Clause 8. The apparatus of any of Clauses 1-7, wherein the at least one factor comprises a memory latency factor indicative of a relative latency of accessing the shared memory location.

Clause 9. The apparatus of Clause 8, wherein the memory latency factor is a static value held as a boot-time set configuration value in the apparatus.

Clause 10. The apparatus of Clause 8, wherein apparatus comprises memory latency determination circuitry configured to determine or estimate the memory latency factor during runtime.

Clause 11. The apparatus of any of Clauses 1-10, wherein the at least one factor comprises a physical memory location factor that is dependent on a proximity of the shared memory location to the load/store circuitry.

Clause 12. The apparatus of any of Clauses 1-11, wherein the apparatus is configured to share a system level cache and the at least one factor comprises at least one of:
a system level cache latency; and/or
snoop hit latency.

Clause 13. The apparatus of Clause 12, wherein the delay circuitry is responsive to control signals generated by the instruction decoding circuitry in response to decoding a shared cache hint instruction to set the delay period in dependence on at least one of: the system level cache latency; and/or the snoop hit latency.

Clause 14. The apparatus of Clause 12, further comprising system level cache hit monitoring circuitry, and the delay circuitry is responsive to a system level cache hit indication from the system level cache hit monitoring circuitry to set the delay period in dependence on at least one of:
the system level cache latency; and/or
the snoop hit latency.

Clause 15. The apparatus of any of Clauses 1-14, wherein the indication of concurrent access to the shared memory location further comprises a contention level indication, and the delay circuitry is configured to use the contention level indication as the at least one factor when setting the delay period.

Clause 16. The apparatus of Clause 15, wherein the contention level indication is provided by a remote node via which access to the shared memory location is made.

Clause 17. The apparatus of Clause 16, wherein the contention level indication is indicative of an activity level of the remote node.

Clause 18. The apparatus of Clause 16, wherein the contention level indication is indicative of a number of requests at the remote node that were hazarded on the shared memory location.

Clause 19. The apparatus of Clause 16, wherein the contention level indication is indicative of a recent number of accesses via the remote node to the shared memory location.

Clause 20. The apparatus of any of Clauses 1-19, wherein the contention delay instruction further comprises a maximum back-off control value and the delay circuitry is configured to limit in dependence on the maximum back-off control value a period for which reissuances of the memory system transaction will occur before the program thread is unblocked.

Clause 21. a system comprising:
the apparatus of any of Clauses 1 to 20, implemented in at least one packaged chip;
at least one system component; and
a board,
wherein the at least one packaged chip and the at least one system component are assembled on the board.

Clause 22. A chip-containing product comprising the system of Clause 21, wherein the system is assembled on a further board with at least one other product component.

Clause 23. A non-transitory computer-readable medium storing computer-readable code for fabrication of an apparatus comprising:
load/store circuitry configured to initiate a memory system transaction to access a shared memory location, wherein the shared memory location is accessible to multiple program concurrent threads,
wherein the load/store circuitry is configured, in response to an indication of concurrent access to the shared memory location by another program thread, to cause a delay of reissuance of the memory system transaction by a delay period; and
delay circuitry configured to set the delay period in dependence on at least one factor determined at runtime.

Clause 24. a method comprising:
initiating a memory system transaction to access a shared memory location, wherein the shared memory location is accessible to multiple concurrent program threads;
in response to an indication of concurrent access to the shared memory location by another program thread, delaying reissuance of the memory system transaction by a delay period; and
setting the delay period in dependence on at least one factor determined at runtime.

In brief overall summary, apparatuses, systems, chip-containing products, non-transitory computer-readable media and methods are disclosed. Load/store circuitry initiates a memory system transaction to access a shared memory location, wherein the shared memory location is accessible to multiple concurrent program threads. In response to an indication of concurrent access to the shared memory location by another program thread, the load/store circuitry causes a delay of reissuance of the memory system transaction by a delay period, wherein delay circuitry is configured to set the delay period in dependence on at least one factor determined at runtime.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

We claim:

1. Apparatus comprising:
load/store circuitry configured to initiate a memory system transaction to access a shared memory location, wherein the shared memory location is accessible to multiple concurrent program threads,
wherein the load/store circuitry is configured, in response to an indication of concurrent access to the shared memory location by another program thread, to cause a delay of reissuance of the memory system transaction by a delay period; and
delay circuitry configured to set the delay period in dependence on at least one factor determined at runtime.

2. The apparatus of claim 1, wherein the delay circuitry is associated with the load/store circuitry and is configured to modify timing of an action of the load/store circuitry in order to implement the delay.

3. The apparatus of claim 1, further comprising an execution pipeline configured to execute a sequence of instructions defining a program thread and wherein the delay circuitry is associated with the execution pipeline, and
wherein the delay circuitry is responsive to a notification from the load/store circuitry of the indication of concurrent access to delay progress of at least one instruction through the execution pipeline in order to implement the delay.

4. The apparatus of claim 3, wherein the delay circuitry is configured to delay progress of the at least one instruction through the execution pipeline by delaying at least one of:
fetching the at least one instruction;
decoding the at least one instruction;
dispatching the at least one instruction;
renaming the at least one instruction; and/or
issuing the at least one instruction.

5. The apparatus of claim 1, further comprising:
instruction decoding circuitry configured to decode instructions of a program thread, wherein the delay circuitry is configured to set the delay period in further dependence on control signals generated by the instruction decoding circuitry in response to decoding a contention delay instruction.

6. The apparatus of claim 2, wherein the contention delay instruction comprises an indication of a scaling factor and the delay circuitry is responsive to the control signals generated by the instruction decoding circuitry to modify the delay period in dependence on the scaling factor.

7. The apparatus of claim 3, wherein plural contention delay instructions each indicating respective scaling factors preceded the memory access instruction in the instructions of the program thread and the delay circuitry is configured to modify the delay period by a combination of the plural scaling factors of the plural contention delay instructions.

8. The apparatus of claim 1, wherein the at least one factor comprises a memory latency factor indicative of a relative latency of accessing the shared memory location.

9. The apparatus of claim 5, wherein the memory latency factor is a static value held as a boot-time set configuration value in the apparatus.

10. The apparatus of claim 5, wherein apparatus comprises memory latency determination circuitry configured to determine or estimate the memory latency factor during runtime.

11. The apparatus of claim 1, wherein the at least one factor comprises a physical memory location factor that is dependent on a proximity of the shared memory location to the load/store circuitry.

12. The apparatus of claim 1, wherein the apparatus is configured to share a system level cache and the at least one factor comprises at least one of:
a system level cache latency; and/or
a snoop hit latency.

13. The apparatus of claim 9, wherein the delay circuitry is responsive to control signals generated by the instruction decoding circuitry in response to decoding a shared cache hint instruction to set the delay period in dependence on at least one of:
the system level cache latency; and/or
the snoop hit latency.

14. The apparatus of claim 9, further comprising system level cache hit monitoring circuitry, and the delay circuitry is responsive to a system level cache hit indication from the system level cache hit monitoring circuitry to set the delay period in dependence on at least one of:
the system level cache latency; and/or
the snoop hit latency.

15. The apparatus of claim 1, wherein the indication of concurrent access to the shared memory location further comprises a contention level indication, and the delay circuitry is configured to use the contention level indication as the at least one factor when setting the delay period.

16. The apparatus of claim 12, wherein the contention level indication is provided by a remote node via which access to the shared memory location is made.

17. The apparatus of claim 1, wherein the contention delay instruction further comprises a maximum back-off control value and the delay circuitry is configured to limit in dependence on the maximum back-off control value a period for which reissuances of the memory system transaction will occur before the program thread is unblocked.

18. A system comprising:
the apparatus of claim 1, implemented in at least one packaged chip;
at least one system component; and
a board,
wherein the at least one packaged chip and the at least one system component are assembled on the board.

19. A chip-containing product comprising the system of claim 21, wherein the system is assembled on a further board with at least one other product component.

20. A method comprising:
initiating a memory system transaction to access a shared memory location, wherein the shared memory location is accessible to multiple concurrent program threads;
in response to an indication of concurrent access to the shared memory location by another program thread, delaying reissuance of the memory system transaction by a delay period; and
setting the delay period in dependence on at least one factor determined at runtime.
